(19) United States
(12) Patent Application Publication
(10) Pub. No.: US 2012/0173884 A1
(43) Pub. Date: Jul. 5, 2012

(54) METHOD FOR REMOTELY CONTROLLING AND MONITORING THE DATA PRODUCED ON DESKTOP ON DESKTOP SOFTWARE

(76) Inventor: Mandar Patil, Aundh (IN)

(21) Appl. No.: 13/381,647

(22) PCT Filed: Jun. 29, 2010
(86) PCT No.: PCT/IB10/52959

§ 371 Date: Mar. 22, 2012

(30) Foreign Application Priority Data
Jul. 1, 2009 (IN) 1543MUM2009

(51) Int. Cl. G06F 21/24; G06F 12/14

(52) U.S. Cl. 713/189; 726/27

(57) ABSTRACT

According to this invention there is provided a method of controlling usage of data and prevent unauthorized usage of data that is generated by software using iso data system where data can be used only on the computer which has created the data or use and/or access the data on other computers only if the owner of such data has given access/permission to such data.

### FIELD OF INVENTION

This invention relates to a method namely ISO data system which provides a protection mechanism to safeguard the data generated by any software, using iso data system, from unauthorized usage.

In particular, iso data system is a method in which data created using the said system is unique and exclusive to the software installed on a particular computer. Data can be used only on the computer that has created it. To use this data on another computer, sufficient access permissions must be given to the data by the owner.

### BACKGROUND OF THE INVENTION

Many a times, data is confidential in nature. Data misuse can lead to serious losses due to which protecting it is very important. Data protection comprises of three main elements, Confidentiality, Integrity and Accessibility. Confidentiality means protecting the data from unauthorized access. Integrity means data can be modified only if appropriate permissions and authorization are given by the data owner. Availability simply means that the data must be available when it is required.

Current available solutions on data security are using passwords, hardware locks, encryptions and similar kind.

### PRIOR ART

US patent application number 20090259512 describes a method of controlling access to a media storage device for storing a plurality of media objects wherein the method includes receiving first data identifying the media storage device and second data identifying a list comprising at least one authorized recipient of the media storage device; storing first data in association with the second data; issuing the media storage device to at least one recipient on the list; using a delivery session identifier to establish a delivery session for the issued media storage device with a user identification system corresponding to recipients associated with the second data; and then updating the second data on the basis of data received from the user identification system and the delivery session identifier, thereby to modify the list of authorised recipients of the issued media storage device.

Further there is also provided a distribution access control system which controls access to a media storage device, the media storage device storing a plurality of media objects, the distributed access control system wherein an interface arranged to receive first data identifying the media storage device and second data identifying a list comprising at least one authorised recipient of the media storage device; a storage system arranged to store the first data in association with the second data; and a device issuing system arranged to issue a media storage device to at least one recipient on the list is provided. Said device issuing system is arranged to create a delivery session identifier to establish a delivery session for the issued media storage device with a user identification system corresponding to at least one recipient associated with the second data, and a storage system is arranged to update the second data on the basis of the delivery session and data received from the user identification system, thereby to modify the list of authorised recipients of the issued media storage device.

### OBJECTS OF THE INVENTION

Data misuse means unauthorized access and usage of data. When data is made unusable for unauthorized recipients, its security no longer remains a problem. Current systems do not have comprehensive and foolproof methods to protect data. It is an object of the present invention to provide a foolproof method to protect, access and usage of data by unauthorized recipients. Even if the data accidentally reaches unauthorized access, it cannot be used and processed. The data created on a particular computer cannot be used on any other computer, unless the data owner has granted the required permissions to each computer on which he wants this data to be shared. The present invention also provides an automated, easy and hassle free software reinstallation system for the user.

### SUMMARY OF THE INVENTION

Registration of the software in the vendor's online server is mandatory for usage of iso data system since this feature can be used only by registered users of the software. The registration system of the software and the iso-data system go hand in hand for data security. After successful registration of the software with the vendor's online server, a unique, permanent, customer id is issued to every registered software. This customer id is unique and important and is used to identify the user of particular software installed in a particular computer. During the software activation, a file is generated by the server. This file is sent to the software. This file is unknown to user and contains keys R1 and R2. The server generates these keys and permanently stores it. The function of these keys is to protect software data from unauthorized usage. These keys are used for encryption and decryption at required stages. Both R1 and R2 are permanent keys, unique to each registered software and are associated with a particular unique customer id with the vendor's online server and with the particular unique installed software. R1 key is used to protect data of the software installed in that particular computer that is owner's data. R1 key is not shared with any other user. By default, the data created by the particular software is always encrypted and stored with R1 key in the computer in which the software is installed. It is a private key. R2 is the key that can be registered with other users on other computers, if needed, with the permission of the owner and is used to protect the data that is being shared. It is a public key of that particular unique software.

Ra and Rb are the private and public key of the recipient, respectively. The public keys and private keys are confidential and will not be used or shared without a purpose. Data owner can register his R2 key with as many recipients as he needs to. These may be recipients to whom owner may need to send data frequently. The data owner will send an instruction to the server to register his R2 key with the recipients, by entering the recipients' customer id's. This instruction will contain the data owner's customer id as well. When the recipient is connected to the online server, an alert will be displayed requesting the recipient to register the data owner's R2 key. It is up to the recipient to register the key or not. At any point of time the data owner can revoke the registration of his R2 key with the other recipients by instructing the server to do so. The server will not need the recipient's permission to revoke the data owner's R2 key registered with a particular recipient.

Data is information created while using the software. The software data can be shared by using any external storage device or by uploading data online to the vendor's server from where the recipient can download it. Owner can set full or partial access permissions for example view, read, print, save and amend. The control of data remains with the data-owner, even after sharing it with other users. Each time authorized recipient accesses shared data, the status of the access permissions will be checked with the online server, if needed. Only if the access permissions are still active, can the recipient access the data else the recipient will be alerted that the data access permissions are no longer valid. Data owner can also send an instruction to the online server to delete the data, he has shared, from the authorized recipient's computer, if needed. Process and storage of original data and data which is received for sharing, are processed through two different and mutually exclusive sub systems which supports encryption system respectively and data is stored in two separate locations in the same computer/system respectively. Data can be protected from unauthorized usage, using iso data system. The process to ensure authorized usage of data, using iso data system, is explained further. In the present embodiment, the environment contains a data owner, a recipient with whom the data owner needs to share the data and an online server. Owner can share data with other registered users. The recipient may or may not have the data owner's R2 key registered with him. In both cases, data sharing can be done by two methods, either by uploading the data set/packet to be shared to the online server or by copying the data to be shared on any external storage device and sharing this device with the intended recipient.

Consider the recipient does not have the data owner's R2 key and the data owner wants to share data by uploading it to the online server. Since the data to be shared is already in an encrypted form with the data owner's R1 key, it is decrypted by the same R1 key and then it is encrypted using the R2 key on the data owner's computer which is controlled by a standard password mechanism each time.

Also the customer id of the recipient as well as sender is entered in this data. Each data set/packet shared by the data owner will contain a particular data id generated by the data owner's system. The said data id will determine uniqueness of each set of data sent to be shared and also will help in the management of the said data. Access permissions and corresponding information of each set of data are associated with its data id. Server will keep a log of all data sets/packets, all attributes associated with their corresponding data ids. This data is then uploaded to the online server where it is again decrypted using the data owner's R2 key and converted into normal/original form. This data is then encrypted with the recipients Rb key. The online server sends an alert to the recipient that certain data is waiting to be shared. The recipient then downloads this data and decrypts it using the data recipient's Rb key.

The same data can be given via an external storage device to the recipient. In this case the recipient will upload this data to the online server. The server will check if the data owner, has set the permission for the particular recipient, customer id which has uploaded the data and only if the permissions are set the data will be processed and sent back to recipient. If the permissions were not granted by the data owner, the online server will delete the data from the recipient's computer. When user uploads this data to the online server the decryption and encryption take place as explained above and when the recipient is connected to the online server he can download and use this data. Now consider the recipient has the data owner's R2 key registered with him. Again the data owner can share the data by uploading it to the online server or by storing the said data to an external storage device and sharing this device with the recipient. In this case the encrypted data is decrypted using the same R1 key and again encrypted using the data owner's r2 key. The recipient can either download this data from the server or from the external storage device; however the data owner has sent it. Since the recipient already has the data owner's r2 registered, the said data can be decrypted using the Owner's Rb key and use it.

Even if the data accidently reaches unauthorized software which has the data owner's R2 key, the data will not be accessed as the customer id of the software in which the data is being opened will differ with the customer id instructed in the authorization.

The shared data can be used with only the authentication of the server and stored in a location separate from original location. The recipient will download the data and import it into the software. Data can be used as per the access rights given with the data. Access rights could be of two types, one is view only where the data can be only viewed not saved and second is full or partial access to use or change the data. The data will behave only in the way the data access and usage permissions have been set by the data owner. For example, the data can be used for x number of days, x number of hours, x number of times, data can or cannot be amended, data can or cannot be saved, data can or cannot be printed.

In case the recipient amends the data and wants to share it back with the data owner, the same can be done by four methods. In method 1, consider, the recipient did not have the R2 key of the data owner. The recipient will encrypt the data to be sent back to the owner with his Rb key. This data which can be sent to the data owner via two methods; one by which the recipient uploads the data to the online server wherein the server converts the data encrypted with Rb key to data owner's R2 key and sends this data to the data owner upon his connection to the online server. The data owner downloads this data and converts it from R2 key to R1 key in order to use it. The recipient can adopt a second method of giving the data encrypted with Rb key to be shared on an external storage device. In this case, the data owner will receive the external storage device and upload this received data to online server where the server will convert the data from Rb key to R2 key and the data owner can download this data and convert the data from R2 key to R1 key and use the data.

In method 2, consider the recipient has the R2 key of the data owner; in this case again the recipient can send the amended data back to the data owner via an external storage device or via uploading the data to be shared to the online server. In both cases the data is encrypted using the data owner's R2 key and sent. Data owner can download this data via the online server or from the external storage device however the recipient has sent it and convert the data from R2 to R1 and use the it.

Amendment of data will be shown to data owner, only if he accepts the amendment, the data will be imported and merged. A facility will be given to the data owner to merge the data that has been amended by the recipient. The data that is to be shared, amended is kept in a separate location from the original location of the software and does not interfere in any way with the original data/records of both users' softwares until an instruction is given to do so. Data owner can keep the original copy if required before amalgamating/integration of the recipient's changes. Same procedure will be applied if data owner wants to share data with more than one recipient.

In case a need arises for the user to reinstall the software, a reinstallation wizard will open. This wizard will take the input of user's email id. After verification, the account details will be fetched from the server and the software will be reinstalled. The server will send a confirmation key to the user's registered email id. The confirmation key is valid only for one particular transaction and is associated to the activation file of that software. The user has to enter the confirmation key sent to the registered email id, into this activation wizard after which an activation file is sent to the software from the server. Incase the motherboard id's of the computer matches with the mother board id registered with the online server when the software was registered, the keys R1, R2 will be restored by the server into the software, The user will have to send a request back to the other users to re register their R2 keys with his software. Incase the motherboard id of the computer differs during the time of reinstallation, the software will be installed but the R2 keys previously registered with the server will not be registered again due to the discrepancy found in the motherboard id and the software will also alert the user to send request again to the various data owners for re registration of their R2 key with the said software.

Each time the software opens, an authorization component matches the motherboard id embedded in the software with the motherboard id of the computer. Incase a discrepancy in the motherboard id is found; the software will get blocked and alert the user to validate with the online server. Once the user validates with the online server, a confirmation key will be sent to the user's registered email id after which the R1 and R2 keys will be sent and restored to the software. The software will also alert the user to send request again to the various data owners for re registration of their R2 key with the said software. Only after data owner's confirmation, their R2 key will be registered with the recipient again. Each time the computer is connected to internet, the server will check the status of the R2 key which is registered with the software. If the server notes that the R2 key of a particular data owner, has been revoked, it will revoke the registration of this R2 key with the recipient. Similarly the recipient can also remove the registration of a particular R2 key by informing the server. In this case the data owner will be alerted about his R2 key being unregistered by a particular recipient.

### ADVANTAGES AND APPLICATIONS

Present invention method Iso data system helps the software owner to protect his software data from unauthorized access. The software owner can set restrictions on data usage by the recipient. Data can be shared by any external drive or by uploading it to the online server.

In view of the wide variety of embodiments to which the principles of the present invention can be applied, it should be understood that the illustrated embodiments are exemplary only. The illustrated embodiments should not be taken as limiting the scope of the present invention. While various elements of the preferred embodiments have been described as being implemented, other embodiments implications may alternatively be used, and vice-versa.

### BRIEF DESCRIPTION OF THE DRAWINGS

FIGS. 1a and 1b illustrates the process of Software registration and use of data by owner.

FIGS. 2a and 2b illustrates the procedure for sharing of data online.

FIGS. 3a and 3b illustrates the process of sharing of data using an external drive like a Compact Disk.

FIGS. 4a and 4b illustrates the process of software reinstallation and reassigning of keys.

FIG. 5 illustrate the process of sharing of R2 key with various potential recipients.

FIG. 6 illustrate the process of revoking R2 key from potential recipients.

FIG. 7 illustrate the process of authorization.

### DETAILED DESCRIPTION OF THE INVENTION

The ISO data system program is a byte code program written in Microsoft .NET programming language.

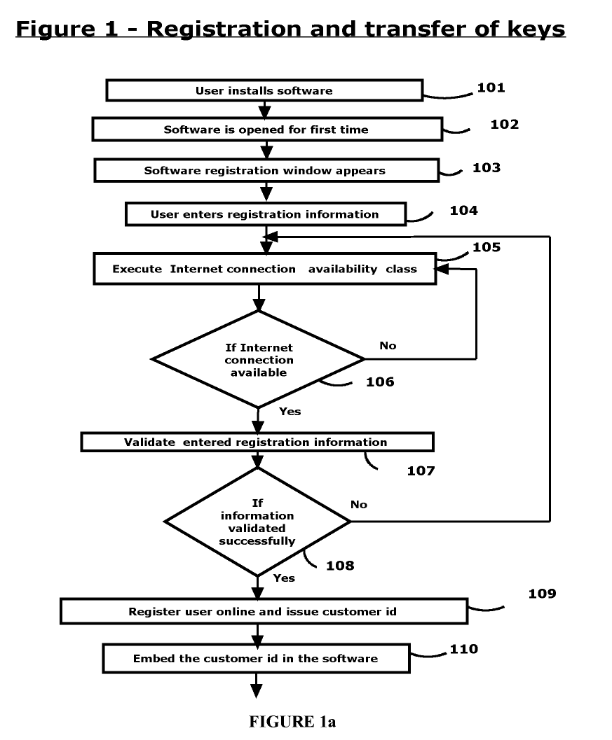

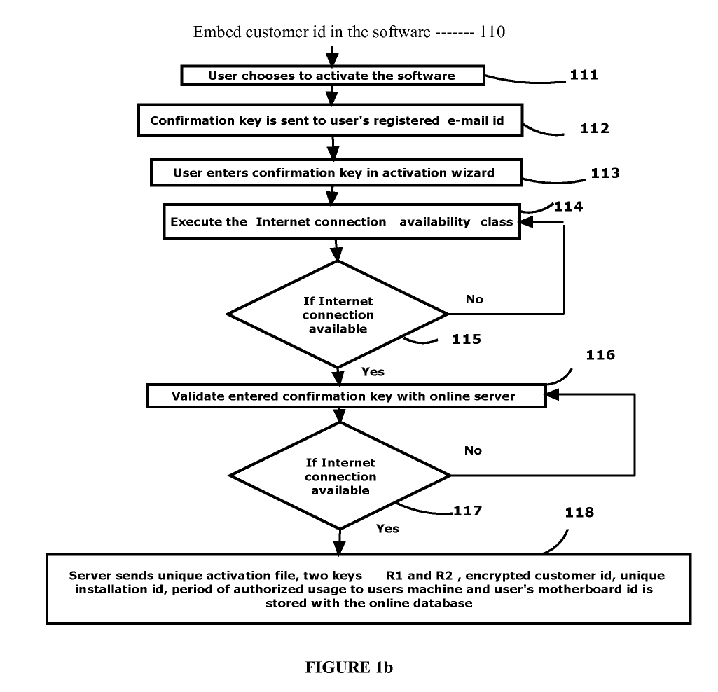

The description generally provides method of protecting the user's data from unauthorized access. A method for registering a user to the online server includes receiving an initial access to desktop software by a prospective user and determining whether the user has provided valid user identification information. Referring to FIG. 1a, User installs the software on his computer by executing function 101, upon successful installation user is ready to use the software. User clicks on the software executable for first time to run the software, method 102 is invoked. When owner uses the software for first time, software registration window 103 will appear to register user to vendor's online server from desktop software. Owner enters registration information via 104 into registration wizard 103. If internet connection is available 105 verifies the integrity of the 105 method associated with each loaded object, if the method 106 is successfully executed the method 107 validates user information upon successful invocation of 108, user is registered to the vendor's online server by invoking method 109 and the server issues unique customer id to the user and embeds customer id in the software by executing method 110. Method 111 (as referred in FIG. 1b) is invoked to display activation wizard, user chooses subscription option i.e. trial or subscription method 112 is invoked to send confirmation key to user's registered email id. Owner enters confirmation key into activation wizard by executing function 113, software executes internet connection availability class 114 to check the internet connection if internet is available, then function 116 execute to validate the confirmation key with the online database by executing internet availability class 117. Upon successful validation server sends activation file with encrypted customer id 118, this activation file also contains two unique keys R1 and R2 for encryption and decryption of software data, installation id, period of authorized usage transferred from online server to user's machine and store users motherboard id to online database. Software creates database encrypted with R1 key of owner.

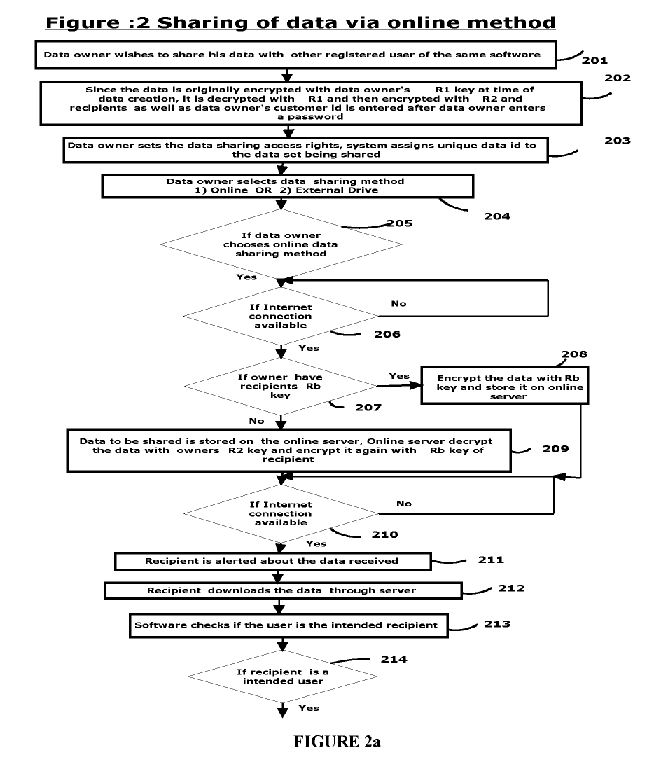

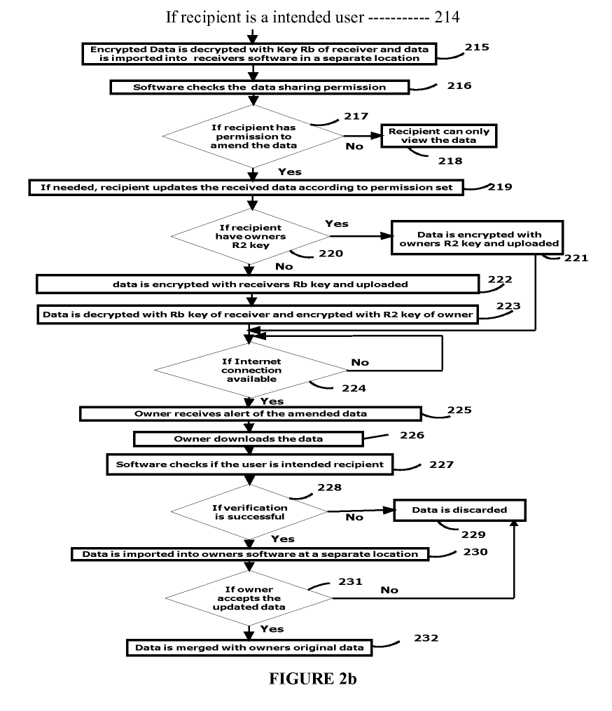

Referring to FIG. 2a, if the data owner wishes to share his data with another registered recipient by executing method 201, Since the data is originally encrypted with the data owner's R1 key at time of data creation, software data is decrypted with data owner's R1 key and then encrypted using data owner's R2 key after the data owner enters a password and customer id is entered by performing method 202; owner sets the data access permissions, system assigns a unique data id to this set of data by executing function 203. User needs to choose the method of sharing of the data, 204. If user chooses the online data sharing method by performing method 205, and If internet connection is available, the software verifies the integrity of the 206 method associated with each loaded object, If the method 206 is successfully executed, 207 is invoked to check whether owner have recipients Rb key If owner have recipients Rb key then function 208 is executed to encrypt the data with Rb key and stores it on online server else method 209 is executed to store the data on the online server with the R2 key, online server decrypts the data with data owner's R2 key and encrypts the data again with Rb key of recipient. If internet connection is available software verifier 210 verifies the integrity of the 210 method associated with each loaded object, If the method 210 is successfully verified 211 is invoked to alert recipient about the data. Recipient downloads the data of owner through server by performing method 212. If the method 214 is successfully verified 215 (as referred in FIG. 2b) is invoked to decrypt the data with receivers Rb key and import it into receiver's software in a separate location. Software verifier 216 checks the data sharing permission, software checks if recipient is having permission to amend the data by performing 217; if method 217 is successfully executed then method 219 is invoked to amend the data according to permission set. If permission is denied to amend the data, recipient can only view the data 218.

After completion of the amendment of the data; Function 220 verifies to check whether recipient have owners R2 key if 220 is successfully executed method 221 is envoked to encrypt the data with owners R2 key and upload it to the online server, else amended data is encrypted with recipient's Rb key and upload the data back to the server by performing method 222. At server, data is decrypted with recipient's Rb key and again encrypted with data owner's key R2 by performing method 223. After this the owner will get the alert of amended data by method 225, If internet connection is available software verifier 224 verifies the integrity of the 224 method associated with each loaded object, If the method 225 succeed to alert the owner, method 226 is invoked to download the data. Software checks if user is intended recipient by performing method 227 and If user verification is correct then verifier 228 verifies the integrity of the 228 method associated with each loaded object, If the method 228 is successfully verified 230 is invoked by owner to import the data into the software at a separate location and if verification failed then data is discarded by performing the method 229. If owner accepts the data by performing method 231, method 232 invoked to merge the data into the original data.

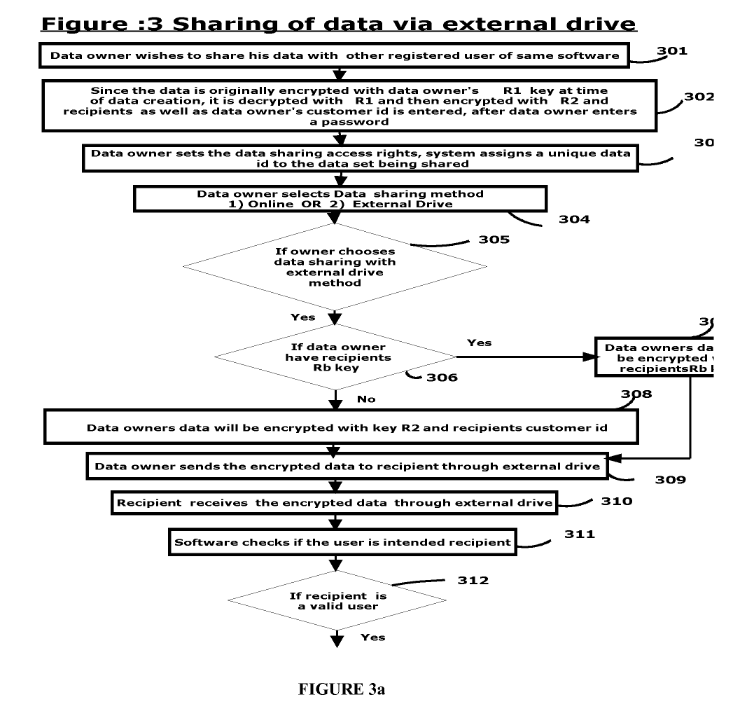

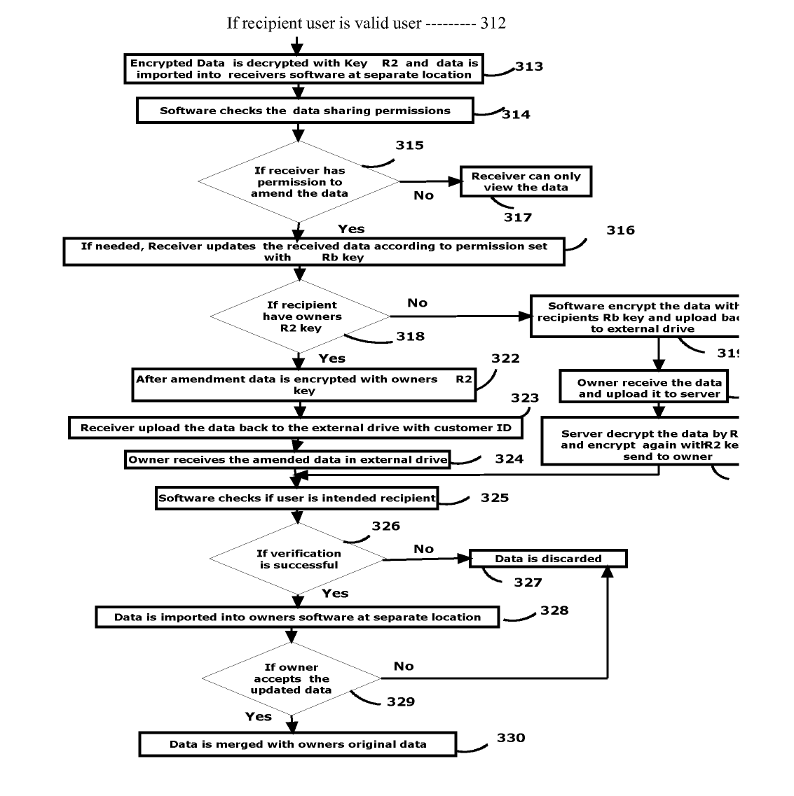

Referring to FIG. 3a, if data owner wishes to share his data with other registered recipients by executing method 301, Since the data is originally encrypted with the data owner's R1 key at time of data creation, software decrypts the data using the R1 key and then encrypts the data using key R2 by performing method 302; this occurs only after the data owner enters a password to execute this transaction. Owner sets the permissions to amend the data and a unique data id is assigned to this set of data by executing function 303. Owner chooses the method of sharing of the data 304 i.e. through online method or through an external drive. If data owner chooses the data sharing method through external drive by performing method 305, Function 306 is invoked to check whether owner have recipients Rb key If owner have recipients Rb key then function 307 is executed to encrypt the data with Rb key and stores it on online server else method 308 is executed to encrypt the data with R2 key and receivers details. Owner sends encrypted data to recipient through external drive by performing method 309. Receiver accepts the data by performing method 310. Software checks the validity of the user by cross checking with customer id by performing method 311 software verifier 312 verifies the integrity of the 312 method associated with each loaded object, If the method 312 is successfully verified 313 (as referred in FIG. 3b) is invoked to decrypt the data and import it into receiver's software. Verifier 314 checks the permission set for the amendment of the data, if receiver is having permission to amend the data by performing 315, if method 315 is successfully executed then method 316 is invoked to decrypt the data with key Ra associated with receiver else receiver can only view the data by performing method 317. With this recipient updates the data of owner according to permission set by performing method 316, After completion of the amendment of the data; Function 318 verifies to check whether recipient have owners R2 key if 318 is successfully executed updated data is encrypted with owner's R2 key by performing methods 322. Recipient uploads the data back to the external drive by performing the function 323, the owner will get the external drive of the updated data by method 324. Else software encrypts the data with recipients Rb key and upload back to external drive by performing method 319, owner receive the data and upload it to the server by performing method 320, at the end of server online server decrypt the data with Rb key and encrypt it again with R2 key and send it to the owner by performing method 321. Software checks if user is intended recipient by performing method 325 and If recipient verification is correct then verifier 326 verifies the integrity of the 326 method associated with each loaded object, If the method 326 is successfully verified 328 is invoked by owner to import the data into the software and if verification fails, the data is discarded by performing the method 327. If owner accepts the data by performing method 329, method 330 is invoked to merge the received data into owner's original data. According to this scenario the given data is protected from unauthorized access.

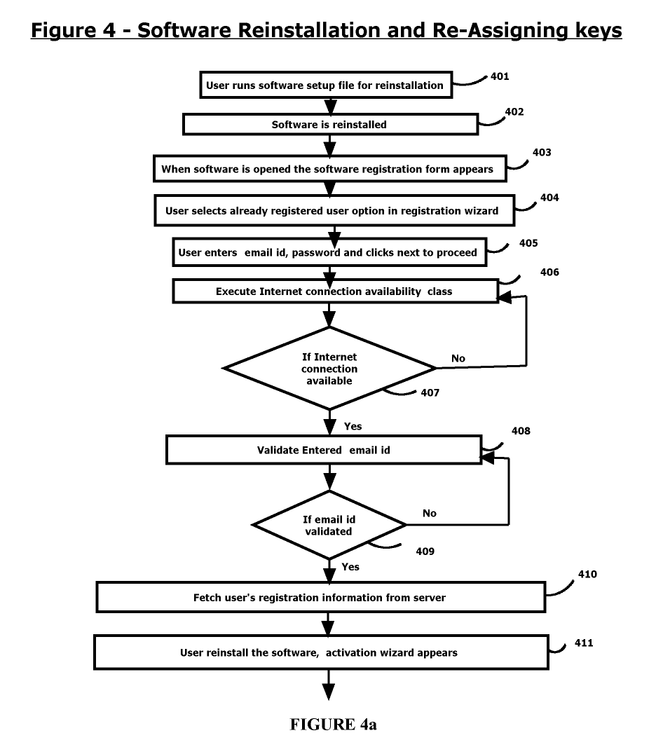

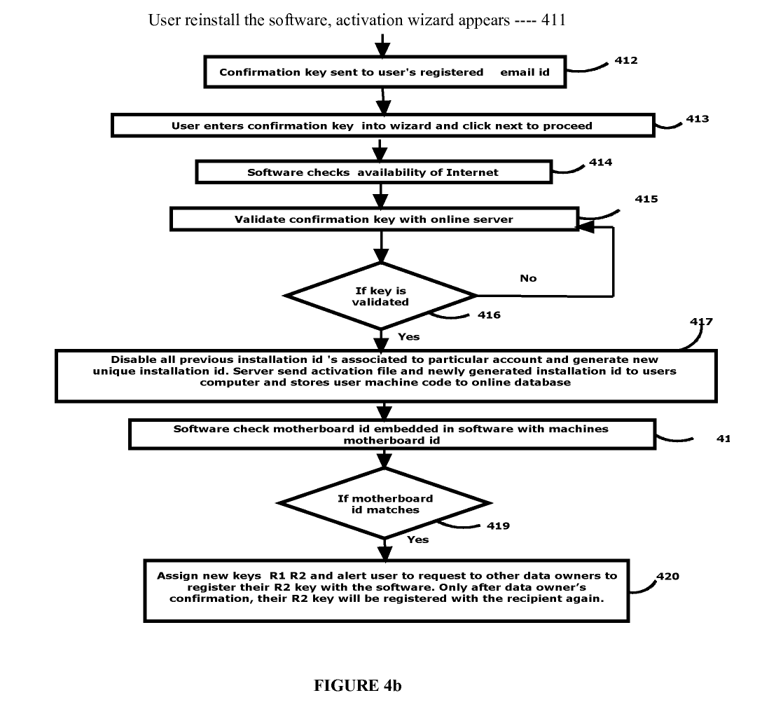

Referring to FIG. 4a, If user needs to reinstall the software due to any reason method 401 is invoked. User reinstalls the software by executing function 402. Method 403 is executed while user clicks to start the software, software registration window 404 will appear, user enters registered email id and password and clicks next, to proceed by executing function 405. If internet connection is available 406 verifies the integrity of the 406 method associated with each loaded object, if the method 407 is successfully verified, 408 is invoked to check entered registration information with vendors online server database. If registration information is validated successfully, 409 verifies its integrity associated with each loaded object, if the method 409 is successfully verified 410 is invoked to fetch all information of customer who has already registered to online server. Method 411 reinstalls the software and invokes method 412 (as referred in FIG. 4b) to send confirmation key to user's registered email id, method enters confirmation key and click next by performing method 413. Software validates confirmation key 415 with online database if key is validated by 416 then disables all previous installation ids for particular user and generates new unique installation id, store machine code to online database by executing function 417. Software checks motherboard id embedded in software with machine motherboard id by executing method 418. Verifier 419 successfully verifies the motherboard id function 420 executes to assign new keys R1 and R2 to user and alert user to send request again to the various data owners for re registration of their R2 key with the software. Only after data owner's confirmation, their R2 key will be registered with the recipient again.

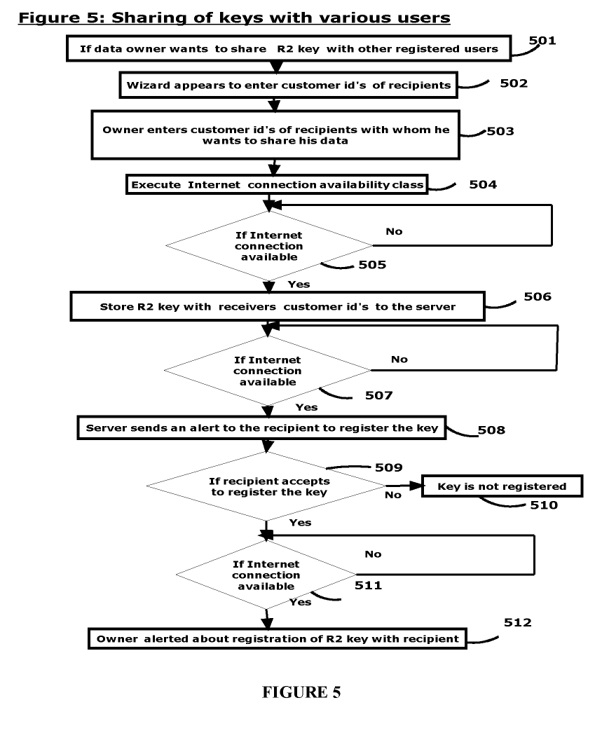

Referring to FIG. 5, if owner wants to share R2 key with other registered users 501 method is invoked. Wizard 502 appears to enter customer id of recipients. Owner enters the customer id of recipients with whom he want to share his data by performing function 503, If internet connection is available connection verifier 504 verifies the integrity of the 505 method associated with each loaded object, If the method 505 is successfully verified 506 is invoked to store R2 key with receivers customer id to the online server. If internet connection is available connection verifier 507 verifies its integrity associated with each loaded object, If the method 507 is successfully verified 508 is invoked to alert the recipient to register the key. Now if user accepts to register the key by executing function 509 then If internet connection is available connection verifier 511 verifies the integrity of the 511 method associated with each loaded object, If the method 511 is successfully verified 512 is invoked to alert owner about registration of R2 key with recipient. If user does not accept 510, the key is not registered.

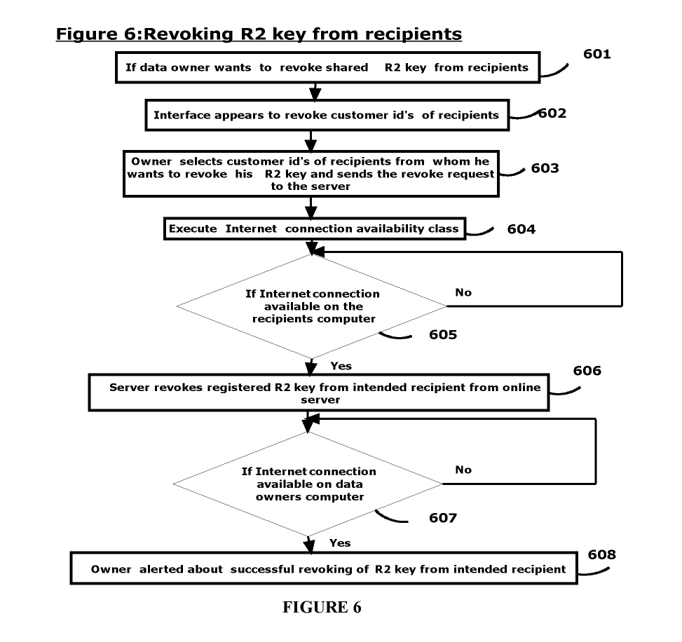

Referring to FIG. 6, if data owner wants to revoke, R2 key shared with other users 601 method is invoked. Interface 602 appears with list of customer id's with whom the data owners R2 key is registered. Owner selects the customer id of recipients from whom he wants to revoke his R2 key and sends this request to online server by performing function 603, If internet connection is available on the recipients computer connection verifier 604 verifies the integrity of the 605 method associated with each loaded object, If the method 605 is successfully verified 606 is invoked to revoke registered R2 key from intended recipient from online server. If internet connection is available on the data owners computer connection verifier 607 verifies its integrity associated with each loaded object, If the method 607 is successfully verified 608 is executed to alert owner about successful revoking of R2 key from intended recipient.

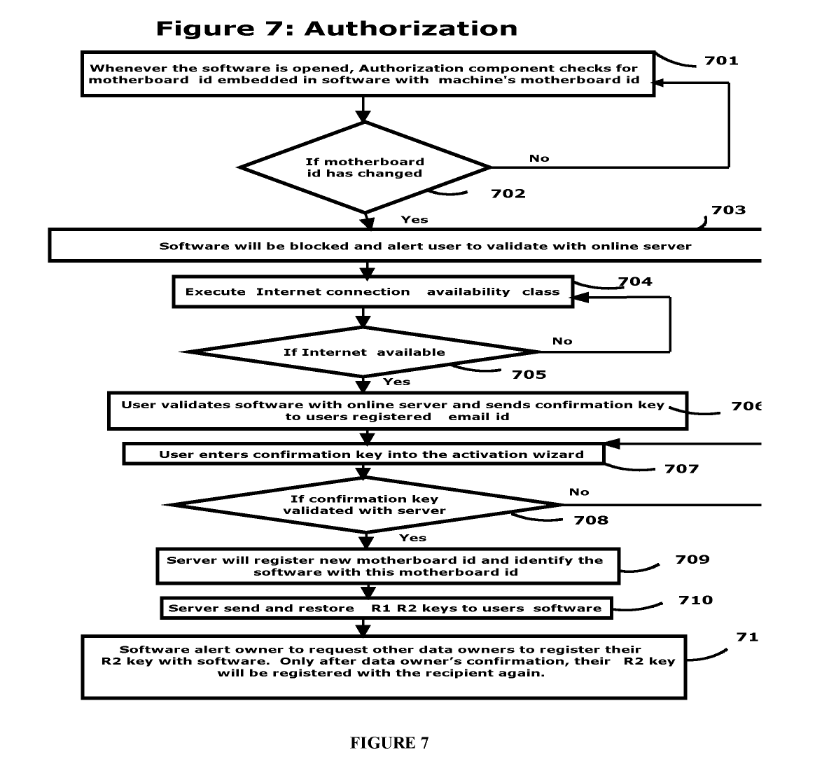

Referring to FIG. 7, Whenever the software is opened, authorization component 701 checks for motherboard id embedded in software with machine's motherboard id. Function 702 checks whether the motherboard ids' have changed, then function 703 will execute to block the software and alert user to validate with online server. If internet connection is available connection verifier 704 verifies the integrity of the 705 method associated with each loaded object, If the method 705 is successfully verified 706 is invoked to validate the software with online server and send confirmation key to user's registered email id. User enters confirmation key into the activation wizard by executing function 707. If verifier 708 validates confirmation key with online server, then function 709 is executed to register new motherboard id with server and identify the software with this motherboard id. Function 710 executes to send and restore R1 R2 keys to user's software. Function 711 will execute to alert owner to request other data owners to register their R2 key with the said software. Only after data owner's confirmation, their R2 key will be registered with the recipient again.

I claim:

1. A method of controlling usage of data and prevent unauthorized usage of data which is generated by software, using iso data system.

2. A method of claim 1 wherein data can be used only on the computer which has created it using iso data system; to use said data on another computer, data owner must authorize a recipient, using the same iso data system on another computer.

3. A method of claim 1, comprising:
selecting the data to be shared and embedding data owner's customer id;
identifying and authorizing at least one recipient with whom the data is to be shared by entering the recipient's customer id;
identifying each set of data being shared by a unique data id generated by the data owner's system where in the access permissions to each set of data are associated with each particular data id;
issuing required access permissions to authorized recipient to use the data;
using appropriate data sharing methods i.e. sharing via uploading the data to the online server or by copying the data to any external storage device.

4. A method of claim 1 wherein, during software activation, the vendors' online server sends two keys namely R1 and R2 to the software. Key R1 is used to encrypt owner's data to protect it from unauthorized usage of this data on any other computer. When data in created in the software it is automatically encrypted with the R1 key and stored in this encrypted form. Key R2 is used to protect the data that is to be shared with one or more intended recipients on their computer system. Ra and Rb are the private and public keys of the recipient.

5. A method of claim 3, wherein data owner can share the data with the recipient via uploading the data to the online server or by transferring data to an external storage device and sharing this device with the recipient.

6. A method of claim 3 where incase the recipient has not yet registered the data owner's R2 key and data to be shared is uploaded to the online server, data is first decrypted using the data owner's R1 key and then encrypted with the data owner's R2 key. This data is uploaded to the server where it is decrypted with data owner's R2 key and again encrypted with the recipient's Rb key. Recipient downloads this data and uses it with his Rb key.

7. A method of claim 3 where incase the recipient has not yet registered the data owner's R2 key and data to be shared is sent to the recipient via an external storage device, data is first decrypted using the data owner's R1 key and then encrypted with the data owner's R2 key. This data transferred to the external storage device and shared with the recipient. The recipient uploads this data to the online server and incase the data owner has given sufficient permissions, the server decrypts this data with the data owner's R2 key and encrypts this data with the recipients Rb key after which recipient can download and use this data with his Rb key.

8. A method of claim 3 where incase the recipient has previously registered the data owner's R2 key and data to be shared is uploaded to the online server, data is first decrypted using the data owner's R1 key and then encrypted with the data owner's R2 key. This data is uploaded to the server, the recipient downloads this data from the server and decrypts and uses the data with the data owner's R2 key.

9. A method of claim 3 where incase the recipient has registered the data owner's R2 key and data is shared via an external storage device, data is first decrypted using the data owner's R1 key and then encrypted with the data owner's R2 key. This data is transferred to the external storage device and shared with the recipient. Recipient downloads this data from the storage device and decrypts and uses the data with the data owner's R2 key.

10. A method of claim 1 wherein, iso data system can be used to protect any data on the data owner's computer/system.

11. A method of claim 3 wherein, the data downloaded by the authorized and designated recipient is bound by certain access rights issued by the data owner; said data can be used by the recipient only as per the access rights set, where said set access rights are viewing, amending, printing and saving.

12. Method of claim 3 wherein, the authorized recipient can amend the data and send it back to the data owner if needed. This amended data will be recognized using a new data id. The data is encrypted with Rb key and uploaded to the server where it is decrypted with the Rb key and again encrypted with the data owner's R2 key. Owner can download this data and convert it back to the R1 key and use it.

13. A method of claim 12, wherein recipient can amend the data shared by the data owner, if needed, and send amended data back to the data owner either via uploading the data to the online server or by transferring data to an external storage device and sharing this device with the data owner.

14. A method of claim 12 where incase the recipient has not yet registered the data owner's R2 key. Amended data to be shared is encrypted with recipient's Rb key and uploaded to the online server, where it is decrypted with the recipient's Rb key and later encrypted with the data owner's R2 key. Data owner downloads this data and converts it from R2 to his R1 key and then uses it.

15. A method of claim 12 where incase the recipient has not yet registered the data owner's R2 key and amended data to be shared is sent to the data owner via an external storage device, data is encrypted using the recipient's Rb key transferred to the external storage device and shared with the data owner. The data owner uploads this data to the online server and incase the recipient has given sufficient permissions, the server decrypts this data with the recipient's Rb key and encrypts this data with the data owner's R2 key after which data owner can download this data, convert it from the R2 key to R1 key and use it.

16. A method of claim 12 where incase the recipient has previously registered the data owner's R2 key and amended data to be shared is uploaded to the online server, data owner downloads this data and decrypts it using his R2 key. Said data can be converted from the R2 key to R1 key and then used.

17. A method of claim 12 where incase the recipient has previously registered the data owner's R2 key and shares the amended data via an external storage device, data owner downloads this data from the storage device and decrypts it using his R2 key. Said data can be converted from the R2 key to R1 key and then used.

18. Method of claim 3 where process and storage of original data and data which is received for sharing, are processed through two different and mutually exclusive sub systems and are at two separate locations in the same computer/system.

19. A method of claim 12 wherein, the data owner is alerted about the amendment done by the authorized recipient in the shared data and can merge it into the original data if required.

20. A method of claim 1 wherein, the data owner can register his R2 key with other recipients for secured data sharing purpose by sending the server an instruction to do so and entering both customer's as well as data owner's customer id. The registration of this key can be revoked at any time by either parties, by sending an instruction to the vendor's online server about the same.

21. A method of claim 3 wherein, the data owner can block the access rights to the data shared with a recipient, by instructing the server to block or delete the data sent to the recipient.

22. A method of claim 3 wherein, even if the data from the recipients computer, is used on any other computer, it cannot be accessed, used or processed, due to lack of permissions from the data owner.

23. A method of claim 1 wherein, in case the software is required to be reinstalled, an easy method of reinstallation is provided to the software user and the server sends the encryption and decryption keys again to the software after activation. It also sends the previously registered R2 keys of other user's into the software.

24. A method of claim 16, wherein incase during reinstallation or each time the software is opened, it is detected that there is the motherboard id of the computer has changed, then the software will have to be revalidated with the server and also the R2 keys will have to be revalidated again by the data owners only then the data sharing from these owners can occur.

25. A method of claim 1 wherein, the iso data system can also be used as an independent encryption module to secure data storage.
